(19) United States
(12) Patent Application Publication
(10) Pub. No.: US 2019/0005268 A1
(43) Pub. Date: Jan. 3, 2019

(54) UNIVERSAL ORIGINAL DOCUMENT VALIDATION PLATFORM

(71) Applicant: Vishal GUPTA, New Delhi (IN)

(72) Inventor: Vishal GUPTA, New Delhi (IN)

(21) Appl. No.: 15/576,730

(22) PCT Filed: May 26, 2016
(86) PCT No.: PCT/IB2016/053086

§ 371 Date: Nov. 24, 2017

(30) Foreign Application Priority Data
May 27, 2015 (IN) 1512/DEL/2015

(51) Int. Cl. G06F 21/64; G06F 21/62; G06F 17/30; G06K 19/06

(52) U.S. Cl. CPC G06F 21/64; G06F 21/6209; G06K 19/06037; G06F 17/30011; G06F 17/30876

(57) ABSTRACT

The present disclosure relates to a system for detecting tampering of a document. In an aspect, the system can include storage of an original document along with its associated at least one digital certificate from at least one issuing authority at a server, and association of a unique identifier with the original document, wherein the unique identifier is also stored corresponding to the original document at the server. The system can further enable creation of another instance of the original document, wherein the instance of the original document includes the unique identifier such that a user of the instance of the original document verifies source and authenticity of the instance of the original document by transmitting the unique identifier to the server in order to retrieve the associated at least one digital certificate based on the unique identifier, and evaluates the retrieved associated digital certificate.

### TECHNICAL FIELD

The present disclosure relates generally to the field of document tampering. In particular, the present disclosure pertains to a system, method, and platform for universal validation of original documents.

### BACKGROUND

Background description includes information that may be useful in understanding the present invention. It is not an admission that any of the information provided herein is prior art or relevant to the presently claimed invention, or that any publication specifically or implicitly referenced is prior art.

Printing a document is a day-to-day feature where users print electronic documents as part of their day-to-day work or record keeping, etc. Further, a print could be in the form of hard copy or in the form of a soft copy. A hard copy is a physical document printed through a printer, fax etc., whereas the soft copy is still in the electronic form, for example in the form of a PDF document.

With the advancements in the communications system, people very frequently send across documents as attachments to others. Since these documents are in electronic form, they are susceptible to being edited at any point of time. As such, anyone can change the content (or other attributes) of a document before printing, making it difficult to say if the printed document is actually a true copy of the original document or has been tampered with. There are prior arts to protect tampering using watermarks, but such mechanisms are very weak in securing documents.

There is therefore a need for a system that allows foolproof security to such printed documents where one can easily verify whether the printed document is a true copy of the original document or is tampered with using a simple to use verification process.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### OBJECTS OF THE INVENTION

A general object of the present disclosure is to provide a system and method for detecting tampering of documents.

Another object of the present disclosure is to associate at least one digital certificate (from one or more issuing authorities) with an original document and storing the original document with the at least one digital certificate on a server/cloud for verification purposes by third parties.

Another object of the present disclosure is to associate a unique identifier/code with an original document so as to use the unique identifier/code to fetch digital certificate(s) associated with the original documents for verification purposes.

### SUMMARY

The present disclosure relates generally to the field of document tampering. In particular, the present disclosure pertains to a system, method, and platform for universal validation of original documents. The proposed system and method can further be used to detect whether an original document (OD) has been tampered with. In an aspect, the proposed system can include storage of an original document along with its associated at least one digital certificate from at least one issuing authority at a server, and association of a unique identifier with the original document, wherein the unique identifier is also stored corresponding to the original document at the server. The system can further enable creation of another instance of the original document, wherein the instance of the original document includes the unique identifier such that a user of the instance of the original document verifies source and authenticity of the instance of the original document by transmitting the unique identifier to the server in order to retrieve the associated at least one digital certificate based on the unique identifier, and evaluates the retrieved associated digital certificate.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary architecture showing various structural elements of the present disclosure.

FIG. 2 illustrates exemplary functional modules of the present disclosure in accordance with an embodiment of the present disclosure.

FIG. 3 illustrates an exemplary logical representation of how original documents along with their respective unique identifiers and digital certificates can be stored on a server.

FIG. 4 illustrates an exemplary flow diagram in accordance with an embodiment of the present invention.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein. To the extent a term used in a claim is not defined, it should be given the broadest definition persons in the pertinent art have given that term as reflected in printed publications and issued patents at the time of filing.

The present disclosure relates generally to the field of document tampering. In particular, the present disclosure pertains to a system, method, and platform for universal validation of original documents.

Although the present disclosure uses the term “digital certificate”, the term can also be interchangeably referred to as “originator certificate” or attributes/parts thereof. Any other term that can indicate a digital certificate being associated with a document is, for instance, well within the scope of the present disclosure.

It would also be appreciated that use of the term “original document” is tied directly with the originator of the document, and is captured with appropriate means without any third-party tampering. In an aspect, the original document may be captured using appropriate encryption techniques to tie the originator with the original document (OD).

In an aspect, the present disclosure relates to a system for validating an original document, wherein the system can include an original document and certificate storage module configured to, through a first computing device, enable storage of the original document along with its associated at least one digital certificate from at least one issuing authority at a server; a unique identifier association module configured to associate a unique identifier with the original document, wherein the unique identifier can also be stored corresponding to the original document at the server; and an original document instance creation module configured to enable creation of another instance of the original document, wherein the instance of the original document can include the unique identifier such that a user of the instance of the original document verifies source and authenticity of the instance of the original document by transmitting the unique identifier to the server in order to retrieve the associated at least one digital certificate based on the unique identifier, and evaluates the retrieved associated digital certificate.

In an aspect, the digital certificate can be retrieved from source URL that is associated with the original document. In another aspect, the digital certificate can be of the owner or creator or of a third party that is associated the original document. In yet another aspect, different original documents can be associated with respective digital certificates that are issued by different issuing authorities. Therefore, the proposed system is compatible/coupled with multiple certificate issuing authorities, and each original document can be associated with a one or more certificate issuing authorities.

In an aspect, the proposed system can further be configured to store additional attributes of the original document at the server, wherein the additional attributes can be selected from one or a combination of source URL associated with the original document, attributes indicating source of the original document, timestamp information, word count, watermark information, checksum of the original document, location, blockchain, access controls, access log, user activity, original document status, integrity of the original document, time, location, authorization, language, translation, optical character recognition, status of the original document or of its subsequent instances, expiry, security attributes, and attributes of the owner or creator of the original document. In an aspect, one or more of such additional attributes of the original document can be presented to the user for verification. In another aspect, one or more additional attributes of the original document can be publicly accessible using the unique identifier.

In an aspect, access controls can use one or more attributes of the user, author of the original document, terminal used for the original document creation, location of original document creation, time of original document creation, authentication, authorization, document signature, decryption key, and the instance of the original document.

In yet another aspect, the system can further be configured to present the original document to the user either along with the associated digital certificate, or upon a verified request from the user so as to enable the user to verify if the instance of the original document has been tampered by comparing it with the presented original document. Such a comparison, in an exemplary aspect, can be done automatically based on any or a combination of content of the documents (original and instance), context of the documents, common attributes of the documents, timestamp information, header information, word count, and checksum of the documents.

In another aspect, the instance of the original document can be in softcopy format or in hardcopy format.

In another aspect, the unique identifier can be associated with the original document by the server. Alternatively, the unique identifier can also be associated with the original document by the driver of a printer, wherein the printer can further enable creation of the instance of the original document.

In an aspect, the unique identifier can be printed on the original document in the form of a machine readable code, which machine readable code can then be scanned from the instance of the original document using a reader in order to be sent to the server to retrieve the at least one associated digital certificate.

In another aspect, the original document can be any or a combination of a file, data, a scanned document, a photo, an image, a screen capture, an xml, a web clipping, a pdf document, a text document, an audio document, a video document, or a signal.

In an aspect, at least one original document can be publicly accessible using the respective unique identifier. Similarly, access to at least original document can also be denied based on any on a combination of blacklisting of accessing user, IP address of the accessing user, classification of the accessing user as a spammer, frequency of access by the accessing user, region from where the at least one original document is accessed, payment constraint associated with the at least one original document, user verification of the accessing user, one time password issued for access to the at least one original document, and user request domain.

In another aspect, the original document can be associated with one or a combination of triggers, notifications, workflows, forms, API, URLs, validation rules, and options.

In another aspect, instance of the original document can be appended with a combination of visual indicator showing association to any of a service, an access key, attributes of original documents, a URL, or a decryption key.

The present disclosure further relates to a method for detecting tampering of a document, wherein method can include the steps of enabling, through a first computing device, storage of an original document along with its associated at least one digital certificate from at least one issuing authority at a server; associating a unique identifier with the original document, wherein the unique identifier is also stored corresponding to the original document at the server; and enabling creation of another instance of the original document, wherein the instance of the original document comprises the unique identifier such that a user of the instance of the original document verifies source and authenticity of the instance of the original document by transmitting the unique identifier to the server to retrieve the associated digital certificate based on the unique identifier, and evaluating the retrieved associated digital certificate.

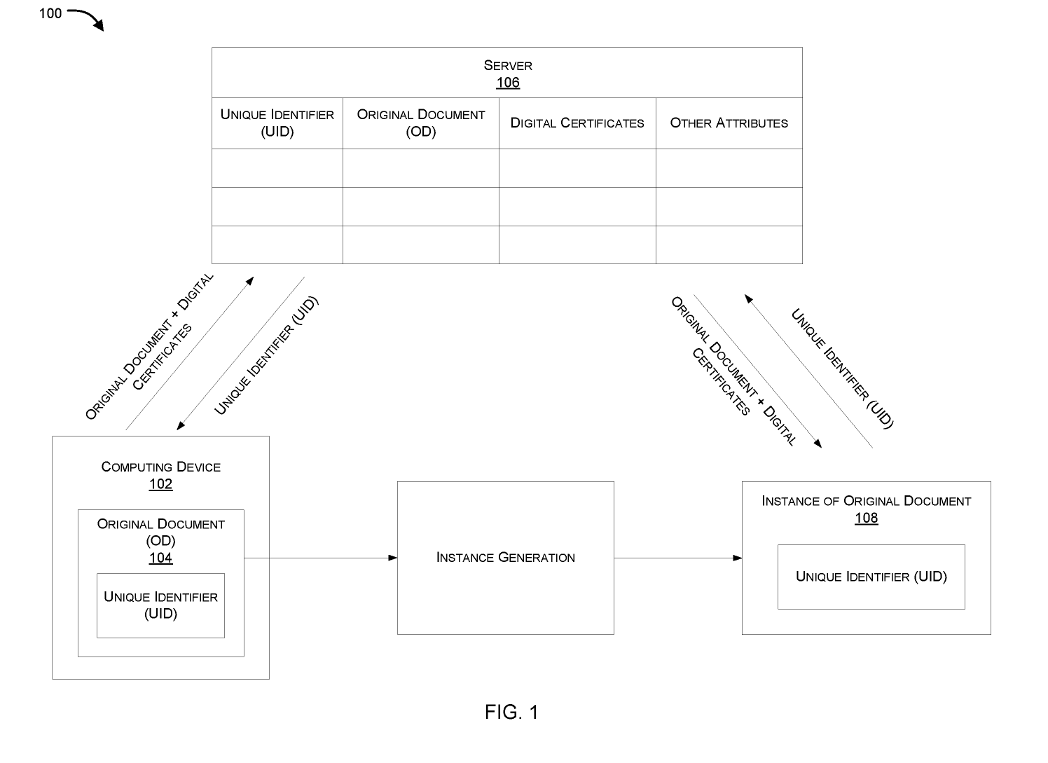

FIG. 1 illustrates an exemplary architecture 100 showing various structural elements of the present disclosure. As shown, the architecture 100 can include a first computing device 102, which can be any or a combination of a laptop, tablet PC, mobile phone, smart phone, personal computer, desktop PC, or any other like computing device can be enable creation and/or access to a document (such as an image, a photo, a video file, a word document, an excel document, a scanned document, a pdf document, or or any other document/file that can be used for implementation of the proposed system), which can be used for creation of and/or access to an original document (OD) 104, tampering of which is to be monitored/detected.

In an aspect, OD 104 can either be created on the first computing device 102, or can opened in say a web browser as a link, attachment, web-page, or any other medium. The OD 104 can also be pre-stored and/or modified by the original creator of the document. Any other mode by means of which the OD 104 is accessed is well within the scope of the present disclosure.

The exemplary architecture 100 can further include a server/cloud 106 where the OD 104 can be stored along with its associated at least one digital certificate issued by at least one issuing authority. For instance, in case the OD 104 is a web page opened through/in a secured URL (such as https), certificate associated with the OD 104 can be transmitted from the device 102 to the server 106. Such transmission of the digital certificate(s) along with the OD 104 can either be automatically done each time a creator creates the OD 104, or can be performed upon explicit instructions from the creator/owner of the OD 104.

As would be appreciated, multiple types of digital signatures exist in the present online/offline computing space. For instance, apart from SSL Certificates associated with secured URLs, each user/creator can also have his/her own digital certificate. Furthermore, Secure Socket Layer Certificate [SSL] Digi-SSL™, Software Signing [Code Signing Certificate] Digi-Code™, Client Certificate [Digital ID] Digi-ID, Certificate Authority (CA) certificates, Server or client certificates, Object signing certificates, Signature verification certificates, and User certificates, among others can also be associated with each OD 104. In an exemplary implementation therefore, any or a part of such certificates can be sent along with the OD 104 to the server 106.

In another aspect, system of the present disclosure can further be configured to associate a unique identifier (UID) with the OD 104, wherein the UID can be stored corresponding to the OD 104 at the server 106. In an aspect, although the exemplary representation of FIG. 1 shows that the UID is generated by the server 106, it should be well appreciated that the UID can also be generated by any other means such as by the driver of a printer that may be used to create further instances/copies of the OD 104. The driver can be configured with modified code that can enable, at the time of creation of an instance of the OD 104, generation and association of a globally UID with the OD 104.

System of the present disclosure can further be configured to enable creation of another instance 108 of the OD 104 (say by means of a printer or through an online PDF generation among other known means), wherein the instance 108 of the OD 104 can include the UID such that a user of the instance 108 of the OD 104 can verify the source and authenticity of the instance 108 of the OD 104 by transmitting the UID to the server 106 in order to retrieve the associated at least one digital certificate based on the UID, and evaluate the retrieved associated digital certificate.

In an aspect, in context of the present disclosure, an instance can be referred to as any second copy/form of the OD 104, be in the soft-copy format or hard-copy format that may be generated through say a printer, a photocopier, or through any appropriate software such as pdf generator or simply by using the Save-As function, for instance. Any other means used to generate another instance/copy of the OD 104 is completely within the scope of the present disclosure.

In an exemplary implementation therefore, a UID such as AART567 can be associated with each instance of the OD 104 by means of a machine-readable code (such as barcode or QR code, for instance) that is printed/embedded visible/non-visible on the OD 104. When a user intends to validate a particular instance 108 of the OD 104, the user can simply scan the machine-readable code through a scanner/reader, which reader can then transmit the UID to the server 106. The server 106 can then match the received UID with a stored UID in order to fetch and present, to the requesting user, information relating to the digital certificate(s) that are stored for the OD 104 that maps with the received UID. Along with the digital certificate(s), the requesting user can also be presented the OD 104 in case the user is authenticated/verified therefor. Review of the digital certificate(s) can enable the user to evaluate the source of the OD 104 along with the other attributes pertaining to the OD 104. Review of the OD 104 can also enable the user to compare the instance (that is with the user) of the OD 104 with the OD 104 to detect if the instance has been tampered with.

In an exemplary embodiment, along with the digital certificates associated with the OD 104, system of the present disclosure can further be configured to store additional attributes of the OD 104 at the server 106, wherein the additional attributes can be from one or a combination of source URL associated with the OD 104, attributes indicating source of the OD 104, timestamp information, word count, watermark information, checksum of the OD 104, location, block chain, access controls, access log, user activity, status of the OD 104, integrity of the OD 104, time, location, authorization, language, translation, optical character recognition, status of the OD 104 or of its subsequent instances, expiry, security attributes, and attributes of the owner or creator of the OD 104.

In an aspect, as mentioned above, the OD can be tied/associated with a block chain to make it part of the validation data to be stored on the server, such that a user intending to validate an instance of the OD can retrieve/evaluate the block chain to authenticate the instance of the OD.

In an aspect, various encryptions technologies are applied during communication and/or storage of original documents.

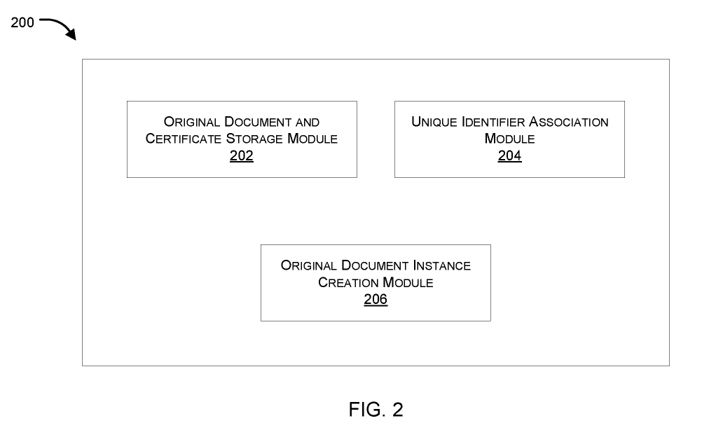

FIG. 2 illustrates exemplary functional modules of the present disclosure in accordance with an embodiment of the present disclosure. In an aspect, the system 200 for detecting tampering of a document can include an original document and certificate storage module 202 that can be configured to, through a first computing device, enable storage of an original document (OD) along with its associated at least one digital certificate from at least one issuing authority at a server. The system 200 can further include a unique identifier association module 204 that can be configured to associate a unique identifier with the OD, wherein the unique identifier (UID) can also be stored corresponding to the OD at the server. System 200 can further include an original document instance creation module 206 that can be configured to enable creation of another instance of the OD, wherein the instance of the OD can include the UID such that a user of the instance of the OD verifies source and authenticity of the instance of the OD by transmitting the UID to the server in order to retrieve the associated at least one digital certificate based on the UID, and evaluate the retrieved associated digital certificate.

In an aspect, the digital certificate associated with the OD can be retrieved from a source URL that enables access to the OD. For instance, in case the OD is an email, or a photo/video/attachment, or a secured file that is opened in an https URL, SSL certificate associated with the https URL can be the one that the OD can be associated with.

In another aspect, the digital certificate can be of the owner or of the creator or of a third-party that is associated the OD. For instance, each owner/creator can have a client digital certificate using which he/she can sign documents, and therefore in case a document is created by a creator, he/she can use his/her personal digital certificate (DC) and associate the same with the OD before the OD is transmitted to the server/cloud. Any update/amendment to the OD can further be stored/updated at the server. For instance, in case the digital certificate using which the OD is accessed changes or is modified, the new digital certificate can be added to the list of DC's that are associated with the OD and accordingly stored on the server. Each OD can therefore be associated with multiple DC's based on its access, creation, updation, and modification patterns. Furthermore, different certificate issuing authorities can be used to generate the certificates, resulting in a scenario where each OD is associated with one or more certificates from same or different issuing authorities. In an aspect therefore, different original documents can be associated with respective digital certificates that are issued by different issuing authorities. Therefore, the proposed system is compatible/coupled with multiple certificate issuing authorities, and each OD can be associated with a one or more certificate issuing authorities.

In an aspect, in addition to DC's, the proposed system can further be configured to store additional attributes of the OD at the server, wherein the additional attributes can be selected from one or a combination of source URL associated with the OD, attributes indicating source of the OD, timestamp information, word count, watermark information, checksum of the OD, location, block chain, access controls, access log, user activity, OD status, integrity of the OD, time, location, authorization, language, translation, optical character recognition, status of the OD or of its subsequent instances, expiry, security attributes, and attributes of the owner or creator of the OD. In an aspect, one or more of such additional attributes of the OD can be presented to the user (along with the DC's associated with the OD) for verification. In another aspect, one or more additional attributes of the OD can be publicly accessible using the UID.

In an aspect, access controls associated with the OD can use one or more attributes of the user (who tries to verify an instance of the OD), author of the OD, terminal used for OD creation, location of OD creation, time of OD creation, authentication, authorization, document signature, decryption key, and of the instance of the OD.

In yet another aspect, the proposed system can further be configured to present the OD to the user either along with the associated DC(s), or upon a verified request from the user so as to enable the user to verify if the instance of the OD has been tampered by comparing it with the presented OD. Such a comparison, in an exemplary aspect, can be done automatically based on any or a combination of content of the documents (OD and the instance of the OD), context of the documents, common attributes of the documents, timestamp information, header information, word count, and checksum of the documents, among other parameters.

In another aspect, the instance of the OD can be in softcopy format or in hardcopy format. For instance, the instance can be a pdf/scan copy of the OD or can be an actual physical hardcopy printout of the OD.

The UID can either be associated with the OD by the server or, in an instance, can also be associated with the OD by the driver of a printer, wherein the printer can further enable creation of the instance of the OD. Driver code for the printer can therefore be modified such that a global UID is generated sooner another instance of the OD is created, and such UID is transmitted to the server to be stored alongside the OD and its digital signature(s)/other attributes.

As explained above, the UID can be printed on the instance of the OD in the form of say a barcode or a QR code or any other machine readable code that can be read by a scanner/code reader, and transmitted to the server so that the server can fetch the OD and its associated digital signatures/other attributes and presented in a defined configured manner to the requesting user who wishes to verify the authenticity of the instance of the OD.

In another aspect, the OD can be any or a combination of a file, data, a scanned document, a photo, an image, a screen capture, an xml, a web clipping, a pdf document, a text document, an audio document, a video document, or a signal. In an aspect, at least one OD can be publicly accessible using the respective UID. Similarly, access to at least OD can also be denied based on any on a combination of blacklisting of accessing user, IP address of the accessing user, classification of the accessing user as a spammer, frequency of access by the accessing user, region from where the at least one original document is accessed, payment constraint associated with the at least one original document, user verification of the accessing user, one time password issued for access to the at least one original document, and user request domain.

In another aspect, the OD can be associated with one or a combination of triggers, notifications, workflows, forms, API, URLs, validation rules, and options. In yet another aspect, instance of the OD can be appended with a combination of visual indicator(s) showing association to any of a service, an access key, attributes of OD, a URL, or a decryption key.

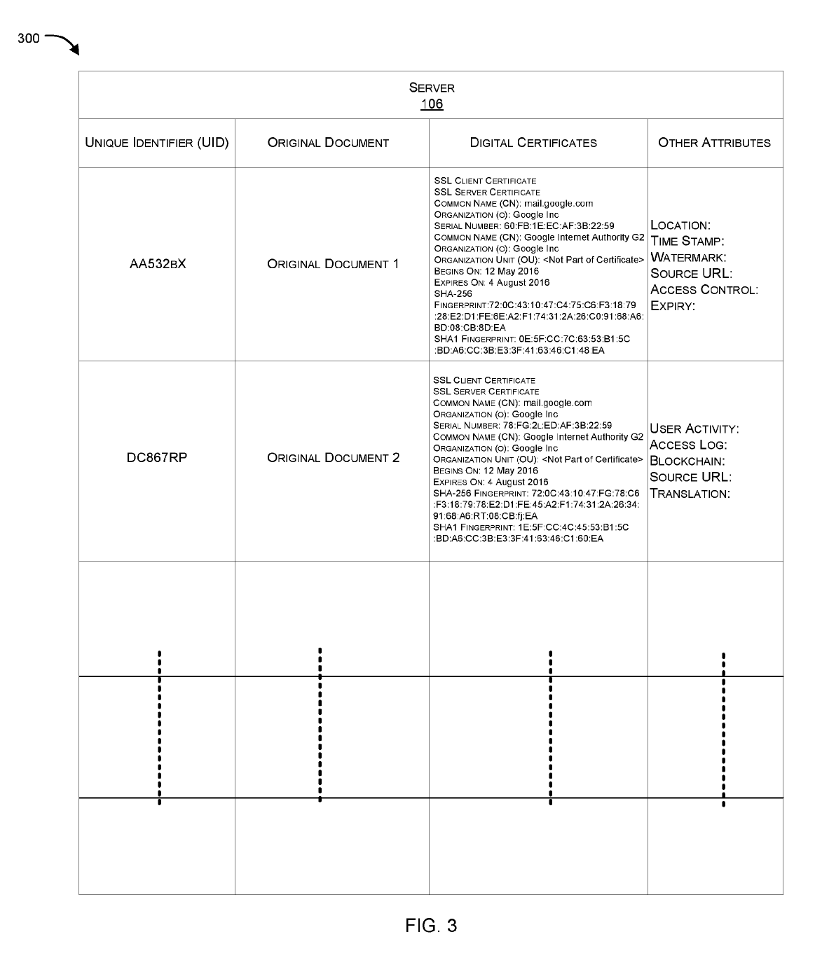

FIG. 3 illustrates an exemplary logical representation of how original documents along with their respective unique identifiers and digital certificates can be stored on a server. As seen, each original document can be associated with one or more digital certificates issued by various issuing authorities. Each OD can further be associated with a unique identifier (UID) that can also be printed on each instance of the OD such that a user intending to verify/authenticate whether the instance of the OD has been tampered can simply scan/enter the UID and send the same to the server, which can retrieve the digital signatures (or configured parts thereof) of the respective OD and present them to the user to view the source/security/creation/updation details pertaining to the OD. Additional attributes such as including but not limited to source URL associated with the original document, attributes indicating source of the original document, timestamp information, word count, watermark information, checksum of the original document, location, block chain, access controls, access log, user activity, original document status, integrity of the original document, time, location, authorization, language, translation, optical character recognition, status of the original document or of its subsequent instances, expiry, security attributes, and attributes of the owner or creator of the original document, can also be stored at the server and presented to the user as desired/configured. User can also be authenticated before sharing any information.

In another aspect, a user can also scan a copy of the instance of the OD itself and send the same over to the server, wherein the server can then automatically process the instance of the OD in order to determine the UID of the OD, and then fetch/match the OD with the instance to detect any tampering based on content, header, creator attributes, timestamp, watermark, among other like attributes that are commonly associated with the documents, and present the output to the user.

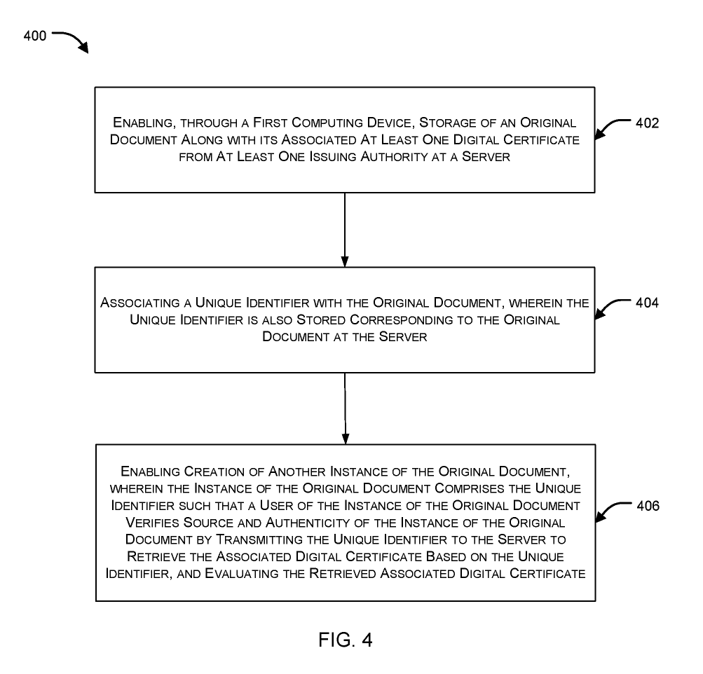

FIG. 4 illustrates an exemplary flow diagram in accordance with an embodiment of the present invention. In an aspect, the proposed method for detecting tampering of a document can include the steps of, at step 402, enabling, through a first computing device, storage of an original document along with its associated at least one digital certificate from at least one issuing authority at a server; at step 404, associating a unique identifier with the original document, wherein the unique identifier is also stored corresponding to the original document at the server; and, at step 406, enabling creation of another instance of the original document, wherein the instance of the original document comprises the unique identifier such that a user of the instance of the original document verifies source and authenticity of the instance of the original document by transmitting the unique identifier to the server to retrieve the associated digital certificate based on the unique identifier, and evaluating the retrieved associated digital certificate.

In an exemplary aspect, tamper detection can be performed by a server by receiving the instance of the OD (also interchangeably referred to as printed document) and comparing one or more attributes of the printed document with corresponding attributes of the OD. In another aspect, the one or more attributes can be selected from one or a combination of content of the documents, timestamp attributes of the documents, user details, word count, location, checksum of the documents, terminal details, header information, document attributes, print source details, website details, watermark details, and number of pages. Any other appropriate attribute is well within the scope of the present disclosure.

In an aspect, the printed document can be printed in any of hardcopy format or softcopy format. In another aspect, the OD can be generated from a website that is opened in a browser. In yet another aspect, the OD is an attachment of an email. In yet another aspect, the UID can be associated with the OD by a driver of a printer being used at the time of printing, wherein the UID can then be stored on a server. In another aspect, the UID can be associated with the received OD by means of a web browser at the time of printing, wherein the UID can then be stored on a server.

In another aspect, the UID associated with the printed document can be either hidden, or can be presented in the form of any or a combination of QR code or barcode, or a computer readable code. Such a code/UID can also be partly represented as an HTTP link for easy access. In an implementation, the UID associated with the printed document can be scanned, and then used to identify the corresponding OD for comparison.

In an aspect, upon authentication, a user can be allowed access to the OD in case the printed document is identified as being tampered with. In another aspect, if the printed document is determined to have been not tampered, the printed document can be shared with one or more users. In another aspect, the UID associated with the OD can be further associated with an access log that can maintain a record/log of access to the OD, and can enable assessment of the attributes (such as user details, timestamp, duration of access, purpose of access, type of access, among other like attributes) of access pertaining to the OD.

In an aspect, when an electronic document is printed, the system can stamp/associate a unique print ID/identifier on one or more pages of the printed document that can be used to verify the origin of the document, and further verify whether the printed document is a true copy of the original (un-tampered) document. The printed document can be in the form of a hard/ soft copy format. In an aspect, the hard copy can be a physical document printed through a printer, fax etc., whereas the soft copy can be in an electronic form, say a PDF document.

In an aspect, the system can include a set of instructions in the form of a program code (hereto onwards printer driver) that can be implemented over the hardware as a printer driver or a plug-in for any browsers or as a browser itself implemented on a client computing device. In an exemplary implementation, at the time of printing a document, the printer driver can verify the website/email client, and fetch one or more digital signatures associated with the OD along with, for instance, source URL (and other additional attributes mentioned above) of the OD to be printed. System of the present disclosure can also generate an overall checksum of the OD and send the same to the server along with the signatures, source information, and other attributes (optional) together with the OD per se. The printer driver can furthermore stamp the UID on one or more pages of the printed document, wherein the UID can be hidden or in the form of any or a combination of QR code or barcode, or a computer readable code. It is to be appreciated that variations in the above-mentioned exemplary implementations are well within the scope of the present invention. For instance, UID can be a global sequential identifier that is to be associated, wherein the identifier may not need to be associated by the printer driver per se, and can also be associated by the client device/browser by means of any plug-in that can be configured in the browser itself, for instance. Any other means of associating a UID with a document to be printed is well within the scope of the present disclosure.

In an aspect, the OD being printed can be a hosted document and/or digitally shared with other people as a file.

In an aspect, the present disclosure relates to an article embedded with a machine readable unique identifier, wherein the article enables scanning of the machine readable unique identifier by a reader to validate or access an original document that the article is an instance of, and wherein the validation enables user of the article to authenticate digital certificate associated with the original document. In an aspect, the scanned machine-readable unique identifier can be sent to a server to enable retrieval of the digital certificate associated with the original document. In an aspect, the server can be a third-party server that stores a plurality of original documents from multiple respective originators along with their respective at least one digital certificate. In an aspect, the article can be a paper or a packing material or any other suitable tangible material on which the UID can be printed.

In another aspect, the original document can be received from any source such as from a website, or an email client or an email (say in the form of an attachment) or from an FTP server, or by means of a hard copy document that is scanned by the original owner of the document, among any other possible source, all of which are well within the scope of the present disclosure.

It would be appreciated the proposed system, method, platform, and architecture has a strong technical effect by enabling any article/surface to be embedded with an ability to validate itself against an original document along with its source. This currently is a huge challenge and authenticity of documents that are normally exchanged between third-parties cannot be established easily and are operating on trust. The proposed invention also has a strong technical effect by means of embedding a UID with a printed document such that the UID can be read by means of an appropriate scanner/reader and such scanning/reading can enable the user to fetch digital certificates (source information) associated with the original document to which the UID pertains. Such evaluation/assessment of digital certificates can help user assess the authenticity/originality/source of the OD, and hence make the instance of the OD being tested more reliable.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE INVENTION

The present disclosure associates at least one digital certificate (from one or more issuing authorities) with an original document and storing the original document with the at least one digital certificate on a server/cloud for efficient verification/validate of the original documents by third parties.

The present disclosure associates a unique identifier/code with an original document so as to use the unique identifier/code to fetch digital certificate(s) associated with the original documents for efficient verification/validate of the original documents by third parties.

The present disclosure provides an article that is embedded with a machine readable unique identifier, where the article enables scanning of the machine readable unique identifier by a suitable reader to validate or access an original document that the article is an instance of, and where the validation enables user of the article to efficiently and accurately authenticate digital/originator certificate associated with the original document.

The present disclosure provides a universal original document validation platform that can be used to prevent any paper fraud, especially in agencies/areas such as government, banking, finance, real estate, among other like industries.

1. A system for validating an original document, the system comprising:
an original document and certificate storage module configured to, through a first computing device, enable storage of the original document along with its associated at least one digital certificate from at least one issuing authority at a server, wherein the server stores a plurality of original documents from multiple respective originators along with their respective at least one digital certificate;
a unique identifier association module configured to associate a unique identifier with the original document, wherein the unique identifier is also stored corresponding to the original document at the server;
an original document instance creation module configured to enable creation of another instance of the original document, wherein the instance of the original document comprises the unique identifier such that a user of the instance of the original document verifies source and authenticity of the instance of the original document by transmitting the unique identifier to the server in order to retrieve the associated at least one digital certificate based on the unique identifier, and evaluates the retrieved associated digital certificate.

2. The system of claim 1, wherein the digital certificate is retrieved from source URL that is associated with the original document or is of the owner or creator or of a third party associated with respective digital certificates that are issued by different issuing authorities.

3. The system of claim 1, wherein the system is further configured to store additional attributes of the original document at the server, wherein the additional attributes are selected from one or a combination of source URL associated with the original document, attributes indicating source of the original document, timestamp information, word count, watermark information, checksum of the original document, location, blockchain, access controls, access log, user activity, original document status, integrity of the original document, time, location, authorization, language, translation, optical character recognition, status of the original document or of its subsequent instances, expiry, security attributes, and attributes of the owner or creator of the original document, and wherein the access controls use one or more attributes of the user, author of the original document, terminal used for the original creation, location of original document creation, time of original document creation, authentication, authorization, document signature, decryption key, and the instance of the original document, and wherein at least a part of the additional attributes of the original document are presented to the user for verification or are made publicly accessible using the unique identifier.

4. The system of claim 1, wherein the system is further configured to present the original document to the user either along with the associated digital certificate, or upon a verified request from the user so as to enable the user to verify if the instance of the original document has been tampered by comparing it with the presented original document wherein such comparison is done automatically, and based on any or a combination of content of the documents, context of the documents, common attributes of the documents, timestamp information, header information, word count, and checksum of the documents.

5. The system of claim 1, wherein the instance of the original document is in softcopy format or in hardcopy format.

6. The system of claim 1, wherein the unique identifier is associated with the original document by the server or by driver of a printer, wherein the printer further enables creation of the instance of the original document.

7. The system of claim 1, wherein the unique identifier is printed on the original document in the form of a machine readable code, and scanned from the instance of the original document using a reader in order to be sent to the server to retrieve the at least one associated digital certificate.

8. The system of claim 1, wherein the original document is any or a combination of a file, data, a scanned document, a photo, an image, a screen capture, an xml, a web clipping, a pdf document, a text document, an audio document, a video document, or a signal.

9. The system of claim 1, wherein at least one of a plurality of original documents are publicly accessible using the respective unique identifier.

10. The system of claim 1, wherein access to at least one of a plurality of original documents is denied based on any on a combination of blacklisting of accessing user, IP address of the accessing user, classification of the accessing user as a spammer, frequency of access by the accessing user, region from where the at least one of the plurality of original documents is accessed, payment constraint associated with the at least one of the plurality of original documents, user verification of the accessing user, one time password issued for access to the at least one of the plurality of original documents, and user request domain.

11. The system of claim 1, wherein the original document is associated with one or a combination of triggers, notifications, workflows, forms, API, URLs, validation rules, and options.

12. The system of claim 1, wherein the instance of the original document is appended with a combination of visual indicator showing association to any of a service, an access key, attributes of orginal documents, a URL, or a decryption key.

13. An article embedded with a machine readable unique identifier, wherein the article enables scanning of the machine readable unique identifier by a reader to validate or access an original document that the article is an instance of, and wherein the validation enables user of the article to authenticate digital certificate associated with the original document.

14. The article of claim 13, wherein the scanned machine readable unique identifier is sent to a server to enable retrieval of the digital certificate associated with the original document and wherein the server is a third-party server that stores a plurality of original documents from multiple respective originators along with their respective at least, one digital certificate.

15. The article of claim 13, wherein the article is a paper.

16. A method for validating an original document, the method comprising the steps of:
enabling, through a first computing device, storage of the original document along with its associated at least one digital certificate from at least one issuing authority at a server;
associating a unique identifier with the original document, wherein the unique identifier is also stored corresponding to the original document at the server;
enabling creation of another instance of the original document, wherein the instance of the original document comprises the unique identifier such that a user of the instance of the original document verifies source and authenticity of the instance of the original document by transmitting the unique identifier to the server to retrieve the associated digital certificate based on the unique identifier, and evaluating the retrieved associated digital certificate.

17. The method of claim 16, wherein the digital certificate is retrieved from source URL that is associated with the original document, or is of the owner or creator of the original document.

18. The method of claim 16, wherein the method further comprises the step of storing additional attributes of the original document at the server, wherein the additional attributes are selected from one or a combination of source URL associated with the original document, attributes indicating source of the original document, timestamp information, word count, watermark information, checksum of the original document, location, and attributes of the owner or creator of the original document.

19. The method of claim 16, wherein the method further comprises the step of presenting the original document to the user either along with the associated digital certificate, or upon a verified request from the user so as to enable the user to verify if the instance of the original document has been tampered by comparing it with the presented original document wherein such comparison Is done automatically, and based on any or a combination of content of the documents, context of the documents, common attributes of the documents, timestamp information, header information, word count, and checksum of the documents.

20. The method of claim 16, wherein the unique identifier is associated by the server or by driver of a printer, wherein the printer further enables creation of the instance of the original document and wherein the unique identifier is printed on the original document in the form of a machine readable code, and scanned from the instance of the original document using a reader in order to be sent to the server to retrieve the at least one associated digital certificate.
